(19) United States
(12) Patent Application Publication
(10) Pub. No.: US 2026/0128529 A1
(43) Pub. Date: May 7, 2026

(54) RADIO WAVE REFLECTING DEVICE

(71) Applicant: Japan Display Inc., Tokyo (JP)

(72) Inventors: Shinichiro OKA, Tokyo (JP); Mitsutaka OKITA, Tokyo (JP); Koichi IGETA, Tokyo (JP); Hiroumi KINJO, Tokyo (JP)

(73) Assignee: Japan Display Inc., Tokyo (JP)

(21) Appl. No.: 19/435,811

(22) Filed: Dec. 30, 2025

Related U.S. Application Data
(63) Continuation of application No. PCT/JP2024/024278, filed on Jul. 4, 2024.

(30) Foreign Application Priority Data
Jul. 13, 2023 (JP) 2023-115084

(51) Int. Cl. H01Q 15/14; H01Q 15/02; H01Q 21/06

(52) U.S. Cl. CPC H01Q 15/14; H01Q 15/02; H01Q 21/065

(57) ABSTRACT

A radio wave reflecting device includes a radio wave reflecting element and a solar cell. The radio wave reflecting element includes a first substrate provided with bias electrodes arranged in a matrix, a second substrate provided with a common electrode facing the first substrate and overlapping the bias electrode, and a liquid crystal layer between the first substrate and the second substrate. The solar cell includes a light guide having a first surface and a second surface opposite the first surface and a side surface between the first surface and the second surface and a light-receiving portion provided along the side surface. The second surface of the solar cell is arranged to face the first substrate of the radio wave reflecting element, and a light receiving surface of the light-receiving portion is arranged on a side of the light guiding portion.

### CROSS-REFERENCE TO RELATED APPLICATIONS

This application is a Continuation of International Patent Application No. PCT/JP2024/024278, filed on Jul. 4, 2024, which claims the benefit of priority to Japanese Patent Application No. 2023-115084, filed on Jul. 13, 2023, the entire contents of each are incorporated herein by reference.

### FIELD

An embodiment of the present invention relates to the configuration of a radio wave reflecting device.

### BACKGROUND

Radio wave reflectors are used to provide radio waves to areas where radio waves are difficult to reach, such as valleys between high-rise buildings (blind zones).

As a radio wave reflecting device, for example, a main array element (dipole element), a sub-array element (non-power supply element), and a common electrode (ground electrode) are installed across a dielectric substrate, and the sub-array element is placed close to the main array element (Japanese laid-open patent publication No. 2011-019021) is disclosed. Also disclosed is a configuration in which the array element and the common electrode (grounding electrode) sandwich a dielectric substrate, and the common electrode has a periodic loop shape (Japanese laid-open patent publication No. 2010-226695).

A reflector of radio waves using liquid crystals controls the direction of reflection of radio waves by changing the alignment state of the liquid crystals. Since the alignment state of the liquid crystal is controlled by the voltage applied to the liquid crystal, electric power is required to drive the radio wave reflector. When a power supply is available at the location where the radio wave reflector is to be installed and power can be easily secured, there is no problem. However, when the reflector is installed on the exterior wall of a building or in a mountainous area, it may be necessary to secure a new power supply.

Photovoltaic power generation can be a candidate as a stand-alone power source, but the installation area will increase when the radio wave reflector and solar cell are placed side by side and placing the radio wave reflector and solar cell on top of each other is expected to affect the radio wave reflection characteristics or the photoelectric conversion efficiency of the solar cell.

### SUMMARY

A radio wave reflecting device in an embodiment according to the present invention includes a radio wave reflecting element and a solar cell. The radio wave reflecting element includes a first substrate provided with bias electrodes arranged in a matrix, a second substrate provided with a common electrode facing the first substrate and overlapping the bias electrode, and a liquid crystal layer between the first substrate and the second substrate. The solar cell includes a light guide having a first surface and a second surface opposite the first surface and a side surface between the first surface and the second surface and a light-receiving portion provided along the side surface. The second surface of the solar cell is arranged to face the first substrate of the radio wave reflecting element, and a light receiving surface of the light-receiving portion is arranged on a side of the light guiding portion.

### BRIEF DESCRIPTION OF DRAWINGS

FIG. 1 is a plan view of a radio wave reflecting device according to an embodiment of the present invention, viewed from the incident side of the radio wave.

FIG. 2 shows a cross-sectional view of the radio wave reflecting device corresponding to the line A1-A2 shown in FIG. 1.

FIG. 3A is a plan view of a photovoltaic element used in a radio wave reflecting device according to an embodiment of the present invention.

FIG. 3B shows a cross-sectional view of the photovoltaic element corresponding to the line B1-B2 shown in FIG. 3A.

FIG. 4 is a plan view of a radio wave reflecting element configured according to an embodiment of the present invention.

FIG. 5 is a cross-sectional view of the radio wave reflecting element corresponding to the line C1-C2 shown in FIG. 4.

FIG. 6 is a plan view of a radio wave reflecting element configuring a radio wave reflecting device according to an embodiment of the present invention.

FIG. 7 is a block diagram illustrating the configuration of the radio wave reflecting device according to an embodiment of the present invention.

FIG. 8 is a cross-sectional view of a radio wave reflecting device according to an embodiment of the present invention.

FIG. 9 is a cross-sectional view of a radio wave reflecting device according to an embodiment of the present invention.

FIG. 10 is a cross-sectional view of a radio wave reflecting device according to an embodiment of the present invention.

FIG. 11 is a cross-sectional view of a radio wave reflecting device according to an embodiment of the present invention.

FIG. 12 is a cross-sectional view of a radio wave reflecting device according to an embodiment of the present invention.

FIG. 13A is a cross-sectional view of a radio wave reflecting device according to an embodiment of the present invention.

FIG. 13B is a cross-sectional view of a radio wave reflecting device according to an embodiment of the present invention.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. In this specification and each drawing, elements similar to those described previously with respect to previous drawings may be given the same reference sign (or a number followed by A, B, or the like) and a detailed description may be omitted as appropriate. The terms “first” and “second” appended to each element are convenient terms used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

The present embodiment is an example of a device integrally equipped with a radio wave reflecting device using liquid crystals and a solar cell that converts light energy into electrical energy. A reflector of radio waves using liquid crystal is a reflector that can reflect radio waves asymmetrically. In the following description, a device equipped with a solar cell and a radio wave reflecting device will be referred to as a “radio wave reflecting device”.

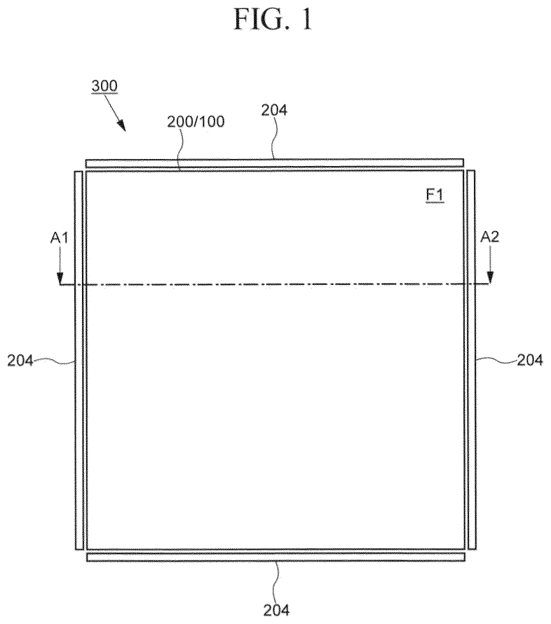

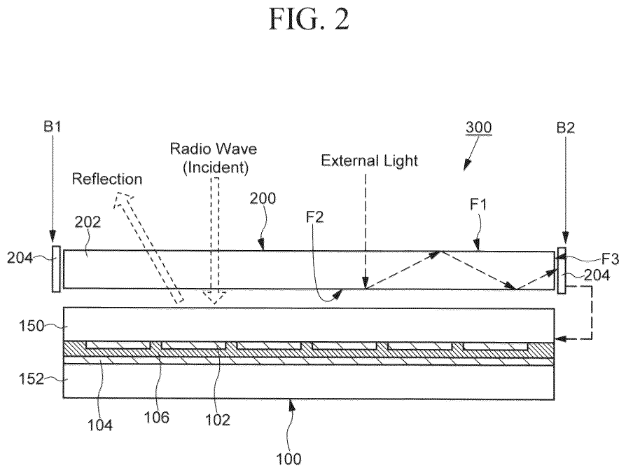

FIG. 1 shows a plan view of the radio wave reflecting device 300 according to the present embodiment, viewed from the incident side of the radio wave. FIG. 2 shows a cross-sectional view of the radio wave reflecting device 300 corresponding to the line A1-A2 shown in FIG. 1. As shown in FIG. 1 and FIG. 2, the radio wave reflecting device 300 includes a radio wave reflecting element 100 and a solar cell 200 overlapping the radio wave reflecting element 100.

The radio wave reflecting element 100 includes a first substrate 150 with a bias electrode 102, a second substrate 152 with a common electrode 104, and a liquid crystal layer 106 between the first substrate 150 and the second substrate 152.

The radio wave reflecting element 100 is an element that reflects radio waves transmitted from a base station or the like in a controlled direction, and in the example shown in FIG. 1, the side of the first substrate 150 is the incident surface of the radio waves. As shown in FIG. 2, the radio wave reflecting device 300 has a structure in which the radio waves pass through the solar cell 200 and enter the radio wave reflecting element 100, since the solar cell 200 is placed on the first substrate 150.

FIG. 2 shows the radio wave reflecting element 100 and the solar cell 200 apart, with an air layer between them. However, the structure shown in FIG. 2 is a schematic example, and the radio wave reflecting element 100 and the solar cell 200 may be installed in contact. A layer of transparent adhesive may be provided between the radio wave reflecting element 100 and the solar cell 200.

The solar cell 200 includes a light guide 202 and a light-receiving portion 204 disposed around the light guide 202. The solar cell 200 is arranged so that the light guide 202 overlaps the radio wave reflecting element 100 in a plan view, and the light-receiving portion 204 does not overlap the radio wave reflecting element 100. More particularly, the light-receiving portion 204 is arranged so that it does not overlap the bias electrode 102 and the common electrode 104 of the radio wave reflecting element 100. The light guide 202 is a plate-shaped member and has a first surface F1, a second surface F2 opposite the first surface F1, and a side surface F3 between the first surface F1 and the second surface F2. The light-receiving portion 204 has a light-receiving surface and is arranged so that the light-receiving surface is opposite the side surface F3. The light-receiving portion 204 may be arranged to be in contact with the side surface F3 of the light guide 202, or an optical system (for example, a lens) may be provided to collect light between the side surface F3 and the light-receiving portion 204.

The light guide 202 is an optical component that guides light incident from the first surface F1 to the side surface F3. For example, the light guide 202 has a characteristic of guiding a portion of the light incident from the first surface F1 to the side surface F3 by total internal reflection and then emitting the light from the side surface F3. The light guide 202 is a transparent member and is formed of an insulating material having a low absorption coefficient with respect to light in at least the visible and near-infrared bands. In other words, the light guide 202 is preferably formed of a material that is transparent, can conduct light, and has little absorption and reflection effects on radio waves in the high frequency bands used in wireless communications. The light guide 202 is preferably formed of a dielectric material such as, for example, glass, quartz, or resin. The light guide 202 may be, for example, aflat plate material called a light guide plate. Fine particles with a refractive index different from that of the base material forming the light guide 202 may be dispersed in the light guide 202. This configuration allows light to be guided to the side surface F3 while scattering the light within the light guide 202.

The light-receiving portion 204 is formed of a photovoltaic element that exhibits a photovoltaic effect (photovoltaic elements are also described below with the same symbol as the light-receiving portion). As the photovoltaic element 204, for example, a photovoltaic element using a silicon semiconductor (silicon solar cell), a photovoltaic element using a compound semiconductor such as gallium arsenide, copper, indium, or selenium (compound semiconductor solar cell), or a photovoltaic element using an organic semiconductor (organic solar cell) can be used.

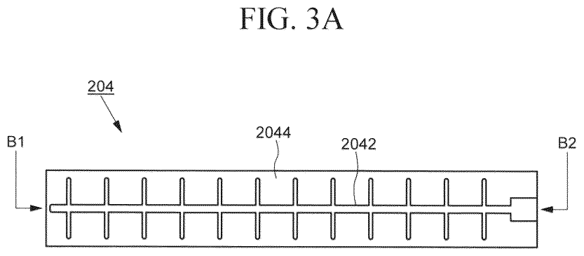

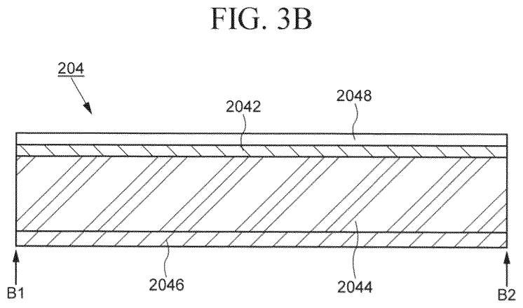

FIG. 3A shows a plan view of a silicon solar cell as an example of the photovoltaic element 204. FIG. 3B shows a cross-sectional view of the silicon solar cell corresponding to the line B1-B2 shown in FIG. 3A. FIG. 3A is a schematic view of the light-receiving surface of the silicon solar cell 200, which has a grid-like surface electrode 2042 on top of a photoelectric conversion layer 2044. As shown in FIG. 3B, a backside electrode 2046 is provided on the back side of the photoelectric conversion layer 2044. Furthermore, an anti-reflective film 2048 is preferably provided on the light-entering surface of the photovoltaic element 204.

The photoelectric conversion layer 2044 includes a p-n junction or pin junction formed by silicon semiconductors. The surface electrode 2042 is the negative side (n-type semiconductor layer side) electrode, and the backside electrode 2046 is the positive side (p-type semiconductor layer side) electrode. The surface electrode 2042 and the backside electrode 2046 are formed of a metallic material such as aluminum.

As shown in FIG. 3A, the photovoltaic element 204 has an elongated rectangular shape in one direction by being positioned along the side of the light guide 202. The surface electrode 2042 provided on the light receiving surface has a grid-like shape to allow light to enter the photoelectric conversion layer 2044 and to reduce in-plane resistance loss. On the other hand, the backside electrode 2046 has a solid shape on the entire surface to reflect light that has not been photoelectrically converted back to the photoelectric conversion layer 2044. As shown in FIG. 1 and FIG. 2, the photovoltaic element 204 is positioned outside of the radio wave reflecting device 100 so that the characteristics of the radio wave reflecting device 300 are not affected, although the metal electrode is provided on the photovoltaic element 204 and thus becomes a factor that impedes the passage of radio waves.

FIG. 1 shows an example in which the light-receiving portion 204 (photovoltaic element) is formed by a single member on each side of the light guide 202, but the radio wave reflecting device 300 according to the present embodiment is not limited to this example. For example, the light-receiving portion 204 (photovoltaic element) may be divided into a plurality of parts at each side of the light guide 202. It is not necessary for the light-receiving portion 204 to surround the entire circumference of the light guide 202 and may be provided on at least a portion of the side surface F3 of the light guide 202. In such a case, the side surface F3 of the light guide 202 where the light-receiving portion 204 is not provided may be covered with a metallic film and have a structure that reflects the light guided therefrom. This configuration can reduce the amount of light leaking from the light guide 202 and increase the amount of light incident on the light-receiving portion 204.

The radio wave reflecting device 300 according to the present embodiment is used as a reflecting surface with the surface on which the solar cell 200 is provided facing outward. Therefore, radio waves transmitted from a base station or the like enter the radio wave reflecting element 100, and external light enters the solar cell 200 in the light guide 202. When external light enters from the first surface F1 of the light guide 202, a portion of the incident light is guided through the light guide 202, repeating total reflection, and is emitted from the side surface F3. The light emitted from the side surface F3 of the light guide 202 is received by the light-receiving portion (photovoltaic element) 204 and generates electric power. The power generated by the light-receiving portion (photovoltaic element) 204 is used to drive the radio wave reflecting element 100. On the other hand, since the light guide 202 is made of a material that neither absorbs nor reflects radio waves, radio waves incident on the light guide 202 enter the radio wave reflecting element 100 without attenuation. The radio waves reflected in the radio wave reflecting element 100 then pass through the light guide 202 again and are emitted at a predetermined angle.

As described above, the radio wave reflecting device 300 according to the present embodiment has an incident surface of external light and an incident surface of a radio wave in common. The light guide 202 is provided on the incident surfaces of the external light and radio waves, and the light guide 202 is formed of a dielectric material, which allows the external light to be guided to the light-receiving portion (photovoltaic element) 204 for power generation and the radio waves to enter the radio wave reflecting element 100 as is and be reflected at a specified angle.

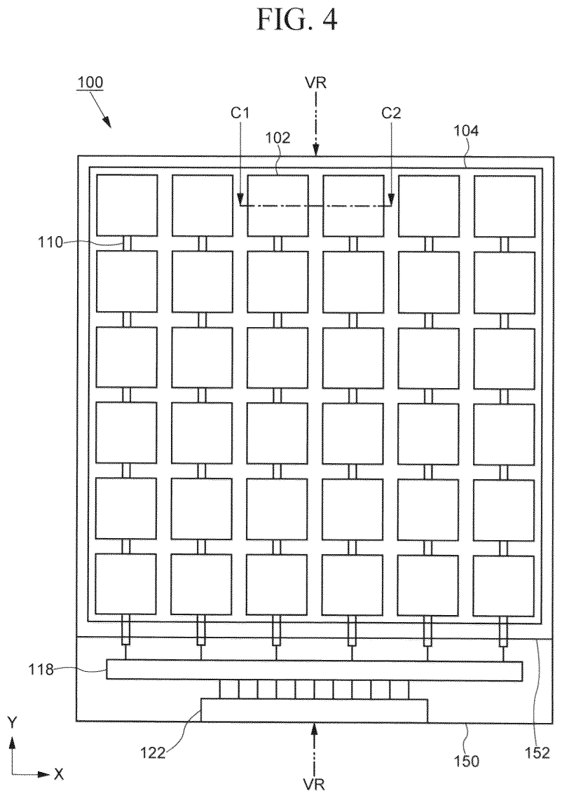

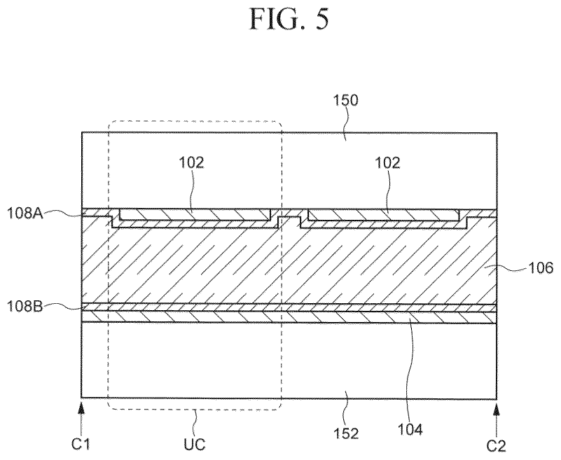

FIG. 4 shows a plan view of the radio wave reflecting element 100 configuring the radio wave reflecting device 300. FIG. 5 shows a cross-sectional view of the radio wave reflecting element 100 corresponding to the line C1-C2 shown in FIG. 4. FIG. 4 and FIG. 5 will be referred to as appropriate in the following description of the radio wave reflecting element 100.

The radio wave reflecting element 100 includes a bias electrode 102, a common electrode 104, and a liquid crystal layer 106 between the bias electrode 102 and the common electrode 104. The bias electrodes 102 are arranged in a matrix in the X-axis and Y-axis directions. The bias electrode 102 and the common electrode 104 are arranged to overlap in a plan view. The common electrode 104 has a size that overlaps the entirety of the bias electrode 102 arranged in a matrix. The X-axis and Y-axis directions shown in FIG. 4 are used for illustrative purposes, and the X-axis and Y-axis directions may be read as the first direction and the second direction that intersects the first direction.

The bias electrode 102 is provided on the first substrate 150 and the common electrode 104 is provided on the second substrate 152. The liquid crystal layer 106 is disposed in a region where the surface on which the bias electrode 102 is provided on the first substrate 150 and the surface on which the common electrode 104 is provided on the second substrate 152 face each other with a gap between them. The first substrate 150 has a region that extends outward from the second substrate 152 in addition to the region facing the second substrate 152. The first driver circuit 118 and terminal part 122 are provided in this region. The first driver circuit 118 functions to output a bias signal to the bias electrode 102. The terminal part 122 is a region that forms a connection with an external circuit, for example, a flexible printed circuit board not shown in the figure. Signals and power to control the first driver circuit 118 are input to the terminal part 122.

Although not shown in the figure, the liquid crystal layer 106 contains liquid crystal molecules in the form of elongated rods. Since the liquid crystal molecules of the liquid crystal used in this embodiment have an anisotropic dielectric constant, the dielectric constant of the liquid crystal layer 106 changes as the alignment state of the liquid crystal molecules changes. Specifically, the alignment state of the liquid crystal molecules can be changed by the potential difference between the bias electrode 102 and the common electrode 104.

As shown in FIG. 5, when the stacked structure of the bias electrode 102, liquid crystal layer 106, and common electrode 104 is considered as one unit cell UC, this configuration can be applied to a patch antenna. In other words, the bias electrode 102 can be regarded as corresponding to a patch, the liquid crystal layer 106 as corresponding to a dielectric, and the common electrode 104 as corresponding to a ground plate. Since the liquid crystal layer 106 has a variable dielectric constant, the phase of radio waves reflected by the radio wave reflecting element 100 varies with the dielectric constant of the liquid crystal layer 106.

The radio wave reflecting element 100 can control the alignment state of the liquid crystal molecules in the liquid crystal layer 106 by individually controlling the potential of the bias electrodes 102 arranged in a matrix. In other words, the radio wave reflecting element 100 can partially vary the dielectric constant of the liquid crystal layer 106 within the plane. With such a function, the radio wave reflecting element 100 can generate a phase difference in the reflected radio wave and control the direction of travel (direction of reflection) to the intended direction.

The initial alignment state of the liquid crystal molecules in the liquid crystal layer 106 (alignment state when no bias voltage is applied) is defined by the alignment film. As shown in FIG. 5, a first alignment film 108A is provided on the first substrate 150 and a second alignment film 108B is provided on the second substrate 152. The first alignment film 108A is provided to cover the bias electrode 102, and the second alignment film 108B is provided to cover the common electrode 104. The first alignment film 108A and the second alignment film 108B are not limited in material and manufacturing method, as long as they have the function of aligning the liquid crystal molecules. The first alignment film 108A and the second alignment film 108B are selected as appropriate, such as a vertically aligned film and horizontally aligned film, depending on the type of liquid crystal. The first alignment film 108A and the second alignment film 108B are formed of, for example, polyimide.

The structure of the radio wave reflecting element 100 shown in FIG. 4 includes bias electrodes 102 arranged in a matrix and connected in series for each array in the Y-axis direction by strip wiring 110. Therefore, the radio wave reflecting element 100 shown in FIG. 4 allows the potential of the bias electrode 102 to be controlled for each array (each row) in the Y-axis direction. On the other hand, the common electrode 104 has a constant voltage commonly applied to the bias electrode 102 arranged in a matrix. The common electrode 104 is controlled to have a ground potential, for example. With this configuration, the radio wave reflecting element 100 can reflect the incident radio waves at different angles in the left and right directions in the figure. with the reflection axis VR parallel to the Y-axis direction.

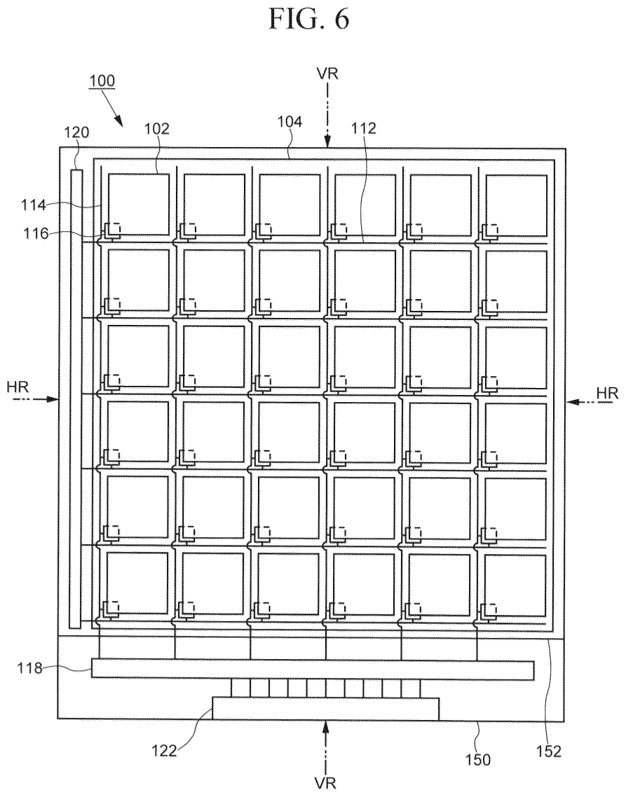

FIG. 6 shows another example of a radio wave reflecting element 100. The following description will focus on the parts that differ from the radio wave reflecting element shown in FIG. 4. The radio wave reflecting element 100 shown in FIG. 6 has scanning signal lines 112 extending in the X-axis direction and bias signal lines 114 extending in the Y-axis direction. The scanning signal lines 112 and bias signal lines 114 are provided on the first substrate 150. In addition to the first driver circuit 118, a second driver circuit 120 is provided on the first substrate 150. The first driver circuit 118 has a function of outputting a bias signal that controls the alignment state of the liquid crystal, and the second driver circuit 120 has a function of outputting a scanning signal. The scanning signal lines 112 and the bias signal lines 114 are arranged to cross each other across an insulating layer, which is not shown in the figure.

The bias signal lines 114 are connected to the first driver circuit 118, and the scanning signal lines 112 are connected to the second driver circuit 120. The bias electrodes 102 arranged in a matrix are each connected to a switching element 116. The switching (on and off) of the switching element 116 is controlled by the scanning signal of the scanning signal lines 112. With this circuit configuration, the bias electrodes 102 arranged in a matrix are selected for each array in the X-axis direction, and a bias signal is applied from the bias signal lines 114. The switching element 116 is formed, for example, by a thin-film transistor.

According to the configuration of the radio wave reflecting element 100 shown in FIG. 6, it is possible to apply a bias signal to each of the bias electrodes 102 arranged in a matrix shape individually. Therefore, the radio wave reflecting element 100 shown in FIG. 6 can control the direction of travel of the reflected wave in the left and right directions of the figure, centering on the reflection axis VR parallel to the Y-axis direction, and also can control the direction of travel of the reflected wave in the vertical direction of the figure, centering on the reflection axis HR parallel to the X-axis direction.

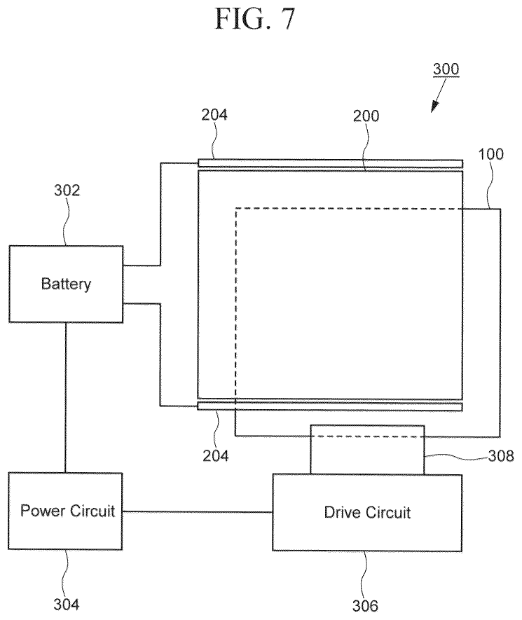

FIG. 7 shows a block diagram of the radio wave reflecting device 300. The radio wave reflecting device 300 includes a battery 302 that stores electricity generated by the light-receiving portion 204, a drive circuit 306 that drives the radio wave reflecting element 100, a power circuit 304 that supplies power from the battery 302 to the drive circuit 306, and a flexible wiring substrate 308 that connects the drive circuit 306 and the radio wave reflecting element 100. As a configuration of the radio wave reflecting device 300, the battery 302 may be dispensed with and the output of the photovoltaic element 204 may be directly supplied to the power circuit 304. However, the radio wave reflecting device 300 is equipped with the battery 302 so that excess power can be stored and the radio wave reflecting element 100 can be driven even at night.

The radio wave reflecting device 300 according to the present embodiment is equipped with the solar cell 200 to provide power to drive the radio wave reflecting element 100. The solar cell 200 is configured with a light guide 202 and a light-receiving portion 204 located on the periphery of the light guide 202. The radio wave reflecting device 300 is arranged so that the light guide 202, which does not affect radio waves, covers the front surface of the radio wave reflecting element 100, and the light-receiving portion 204 is positioned outside of the radio wave reflecting element 100. This arrangement allows the light receiving area to be secured for the solar cell 200 and the radio wave reflecting element 100 to be unaffected by reflection of radio waves. For example, a film-type battery can be used as the battery 302. The film-type battery can be placed on the back of the radio wave reflecting element 100. This configuration allows the radio wave reflecting device 300 to be installed and driven even in locations where it is difficult to secure a power source.

As described above, the radio wave reflecting device 300 according to the present embodiment has a solar cell 200 placed on the reflecting surface of the radio wave reflecting element 100, and the light-receiving surface of the solar cell 200 is configured with a material that does not affect the transmission of radio waves, so that it is possible to drive the radio wave reflecting element 100 to reflect incident radio waves in a predetermined direction while generating power using external light. Since the radio wave reflecting device 300 can use the power generated by the solar cell 200 as power to drive the radio wave reflecting element 100, the radio wave reflecting device 300 can be installed even in locations where it is difficult to secure a power source.

### Second Embodiment

The present embodiment shows an example of a radio wave reflecting device 300 in which the configuration of the light guide 202 differs from that of the first embodiment. The following description will focus on the parts that differ from the first embodiment, and common parts will be omitted as appropriate.

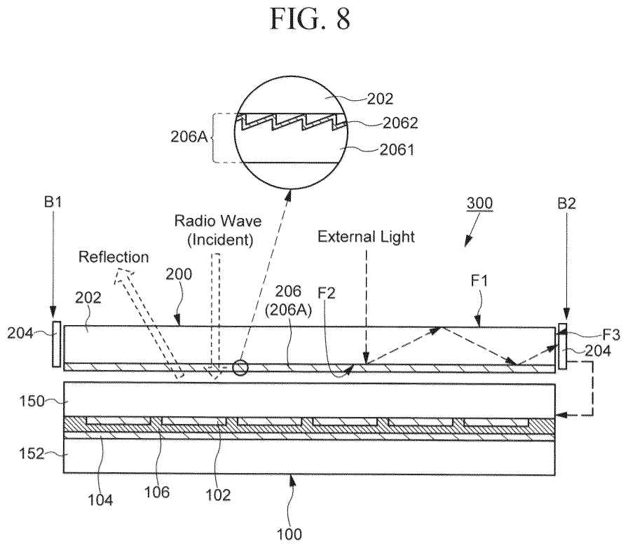

FIG. 8 shows a cross-sectional view of the radio wave reflecting device 300 according to the present embodiment. Similar to the first embodiment, the structure of the radio wave reflecting device 300 includes a solar cell 200 arranged on the surface of and overlapping the radio wave reflecting element 100. The solar cell 200 includes a light guide 202 and a light-receiving portion 204, and a functional member 206 is added to the light guide 202 to guide external light.

The functional member 206 is disposed on the second surface F2 of the light guide 202. The functional member 206 is, for example, a reflective diffraction lattice 206A. The structure of the reflective diffraction lattice 206A includes grooves (parallel grooves) formed on a flat surface formed by a dielectric substrate 2061 and a metallic film 2062 provided on the surface. The reflective diffraction lattice 206A is preferably provided on the second surface F2 of the light guide 202 so that it overlaps the entire surface. The reflective diffraction lattice 206A has the metallic film 2062 formed on its surface to reflect incident light at a predetermined diffraction angle, but the metallic film 2062 is preferably thin to reduce its effect on radio waves. For example, the metallic film 2062 formed on the surface of the reflective diffraction lattice 206A is preferably, for example, 50 nm or less. With such a thin metallic film 2062, radio waves can be reflected without attenuation, although there is a slight decrease in reflectivity.

With this configuration, light transmitted through the light guide 202 is diffracted by the reflective diffraction lattice 206A and re-entered into the light guide 202, thereby increasing the amount of light guided by the light guide 202. FIG. 8 shows a configuration in which the functional member 206 is disposed on the second surface F2 side of the light guide 202, but the functional member 206 may be provided on the first surface F1 side of the light guide 202.

The radio wave reflecting device 300 according to the present embodiment has, in addition to the configuration shown in the first embodiment, the functional member 206 added to the light guide 202 that constitutes the solar cell 200. It is possible to increase the amount of light guided through the light guide 202 and to increase the amount of power generated by the photovoltaic element 204 by using the configuration of the second embodiment. Other configurations are similar to the first embodiment, and the same effects can be obtained.

### Third Embodiment

The present embodiment shows an example of a radio wave reflecting device 300 in which the configuration of the functional member 206 differs from that of the second embodiment. The following description will focus on the parts that differ from the second embodiment, and common parts will be omitted as appropriate.

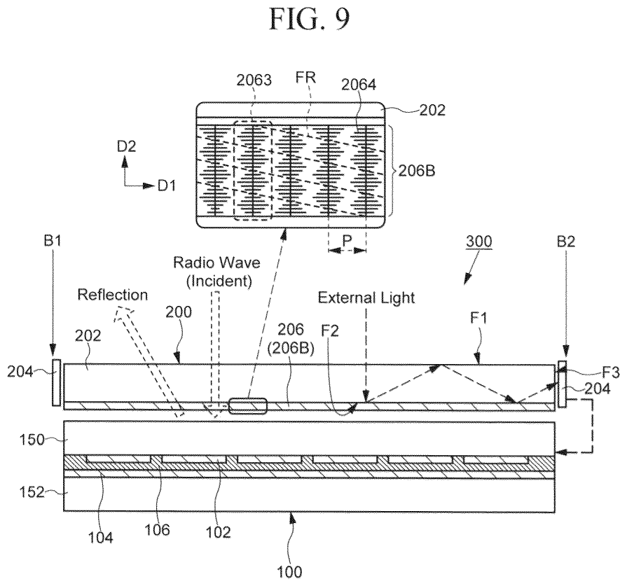

FIG. 9 shows the configuration of the radio wave reflecting device 300 according to the present embodiment. FIG. 9 shows a configuration in which an optical diffraction layer 206B is used as the functional member 206. The optical diffraction layer 206B has a property of reflecting and diffracting at least some wavelength bands of the incident light toward the light guide 202. Specifically, the optical diffraction layer 206B has optical anisotropy (birefringence) and multiple optical axes. The optical anisotropy is, for example, uniaxial optical anisotropy.

FIG. 9 schematically shows the structure of the optical diffraction layer 206B in the inset. The optical diffraction layer 206B includes a plurality of helical structures 2063. Each of the plurality of helical structures 2063 extends in the direction D2 and is arranged at intervals P in the direction D1. The direction D2 in which each of the plurality of helical structures 2063 extends is perpendicular to the second surface F2 of the light guide 202.

The plurality of helical structures 2063 are configured, for example, with a plurality of liquid crystal molecules 2064. In this case, the plurality of helical structures 2063 have a structure in which the plurality of liquid crystal molecules 2064 are stacked while spiraling along the direction D2. In other words, each of the helical structures 2063 has a structure in which the plurality of liquid crystal molecules 2064 are arranged in a helical manner while changing their alignment direction along the direction D2. Since the period of the helix of the helical structure 2063 is relatively large, the optical diffraction layer 206B functions as a reflective diffraction lattice that reflects light.

The optical diffraction layer 206B is made by stacking a plurality of liquid crystal molecules in each of a plurality of helical structures 2063 while changing their alignment direction in a helical manner along the direction D2, and such a plurality of helical structures 2063 are periodically arranged in the direction D1, the optical diffraction layer 206B has a structure in which the refractive index changes gradually, and Fresnel reflection is gradually generated for the incident light. The Fresnel reflection is strongest at the position where the refractive index changes most significantly in the optical diffraction layer 206B. The inset of FIG. 9 shows the reflection surface FR by connecting the region where the Fresnel reflection is strongest with a straight line.

Since the plurality of liquid crystal molecules 2064 are periodically stacked while changing their alignment direction in a helical manner in the direction D2, a plurality of reflective surfaces FR is formed in the optical diffraction layer 206B. The plurality of reflective surfaces FR is parallel to each other. The plurality of reflective surfaces FR is inclined to the second surface F2 of the light guide 202 and have an abbreviated planar shape extending in a constant direction. The plurality of reflective surfaces FR selectively reflects light incident from the light guide 202 according to Bragg's law. In other words, the optical diffraction layer 206B reflects and diffracts at least a portion of the wavelength band of the incident light and causes the light to re-enter the light guide 202.

The optical diffraction layer 206B preferably transmits at least a portion of the wavelength band of light in the visible light band of the light incident on the optical diffraction layer 206B from the light guide 202 and reflects and diffracts a portion of the light in the visible to near-infrared light band. The optical diffraction layer 206B can reflect and diffract at least a portion of the incident light so that the diffracted light is re-injected into the light guide 202 and guided. This can increase the amount of light that is guided by the light guide 202 and emitted from the side surface F3. The light guided by the light guide 202 and emitted from the side surface F3 can be light in a specific wavelength band. In this case, the light of the specific wavelength band is preferably light of a wavelength band with high light collection efficiency in the photovoltaic element 204.

The optical diffraction layer 206B may be in contact with the light guide 202, or a transparent layer such as an adhesive layer may be interposed between the optical diffraction layer 206B and the light guide 202. The optical diffraction layer 206B may be flexible, for example. The refractive index of the layer interposed between the optical diffraction layer 206B and the light guide 202 is preferably equal to the refractive index of the light guide 202.

As described above, the optical diffraction layer 206B forms a reflective diffraction lattice with a liquid crystal layer. Cholesteric liquid crystal can be used as the liquid crystal material. The optical diffraction layer 206B is formed by a pair of glass substrates, a light distribution film, and a liquid crystal material, and no electrodes are used. Therefore, it is possible to transmit radio waves without absorbing them.

The radio wave reflecting device 300 according to the present embodiment is formed by forming the functional member 206 shown in the second embodiment with an optical diffraction layer 206B using a liquid crystal material, the amount of light guided through the light guide 202 can be increased, and the amount of electricity generated by the photovoltaic element 204 can be increased. The other configurations are the same as in the first embodiment, and the same effects can be obtained.

### Fourth Embodiment

An additional wavelength-convertible member may be added to the configuration of light guide 202 shown in the second and third embodiments.

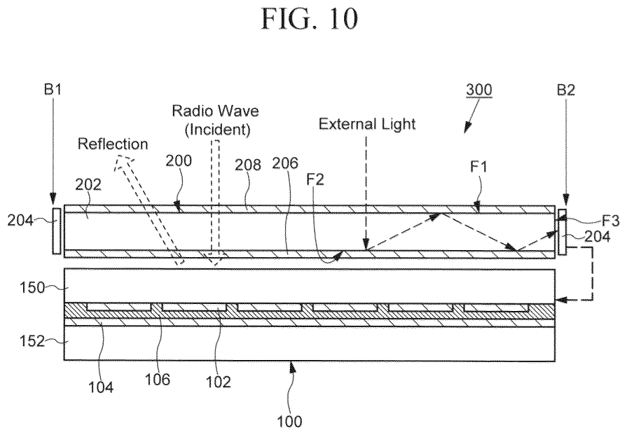

FIG. 10 shows the configuration of the radio wave reflecting device 300 according to the present embodiment. The wavelength conversion layer 208 is provided on the first surface F1 of the light guide 202 in a configuration in which the solar cell 200 and the radio wave reflecting element 100 are arranged on top of each other. The functional member 206 (optical diffraction layer 206B) shown in the third example has improved wavelength selectivity of diffracted light. Therefore, it is possible to increase the utilization efficiency of the incident light by wavelength conversion using the wavelength conversion layer 208 to conform to the wavelength of the functional member 206 (optical diffraction layer 206B).

Specifically, when the light diffracted by the functional member 206 (optical diffraction layer 206B) is in the near-infrared band (wavelength 750 nm to 1000 nm), the wavelength conversion layer 208 can increase the light utilization efficiency by converting the light in all or part of the ultraviolet to visible light bands into light in the near-infrared band. While the wavelength conversion layer 208 converts visible light, which is incident light, into light in the wavelength band (for example, infrared light) with high collection efficiency of the photovoltaic element 204, it may convert ultraviolet light into visible or infrared light, or infrared light into visible light. Such a wavelength conversion layer 208 can be formed by applying, for example, an inorganic phosphor or an organic fluorescent emitter.

According to the present embodiment, it is possible to increase the amount of power generated by the photovoltaic element 204 because the wavelength conversion layer 208 in the light guide 202 can increase the amount of light in a specific wavelength band among the light diffracted by the functional member 206 (optical diffraction layer 206B) and re-injected into the light guide 202. Other configurations are the same as in the first embodiment, and the same effects can be obtained.

### Fifth Embodiment

A light scatterer may be used in place of the diffraction lattice in the functional member 206 shown in the second embodiment.

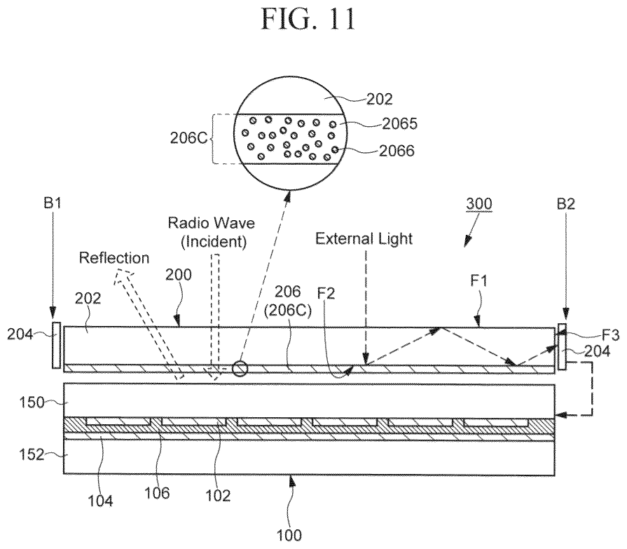

FIG. 11 shows a cross-sectional view of the radio wave reflecting device 300 according to the present embodiment. As shown in FIG. 11, a light scattering layer 206C that scatters light transmitted through the light guide 202 is used as the functional member 206. The light scattering layer 206C has light scattering fine particles 2066 dispersed in a resin layer 2065 formed in a sheet form. The fine particles 2066 are preferably of the same particle diameter as the wavelength of the light to be scattered. The fine particles 2066 are not uniform in diameter and may be mixed with different particle diameters to scatter light in a predetermined wavelength band.

The resin layer 2065 is formed of, for example, acrylic, epoxy, vinyl, fluorine, or polyester resin. The fine particles 2066 are formed of an inorganic or organic material (resin material). For example, the fine particles 2066 can be formed of materials such as titanium oxide and silica. FIG. 11 shows an example of the resin layer 2065 having a planarization surface, but the surface of the resin layer 2065 may be made uneven by the fine particles 2066.

According to the functional member 206 shown in the present embodiment, the light transmitted through the light guide 202 can be scattered and the scattered light can be re-entered into the light guide 202, thereby increasing the amount of light incident on the photovoltaic element 204. Since the fine particles 2066 are only dispersed in the resin layer 2065, it is possible to prevent attenuation of radio waves incident on and reflected by the radio wave reflecting element 100. The other configurations are the same as in the first embodiment, and the same effects can be obtained.

### Sixth Embodiment

The present embodiment shows a radio wave reflecting device 300 having a different configuration of the light guide 202 from that of the first embodiment. The following description will focus on the parts that differ from the first embodiment, and common parts will be omitted as appropriate.

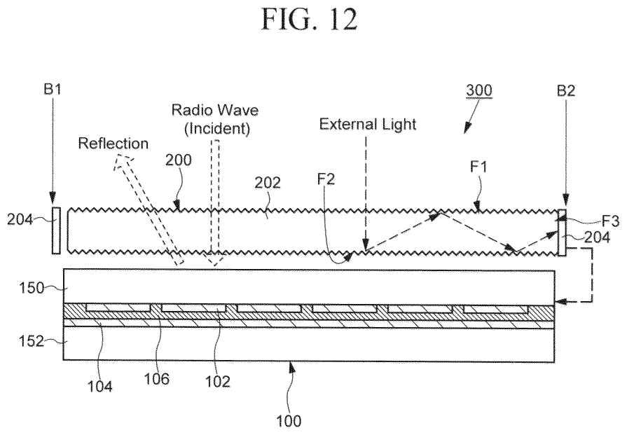

FIG. 12 shows a cross-sectional view of the radio wave reflecting device 300 according to the present embodiment. The structure of the radio wave reflecting device 300 includes a solar cell 200 and a radio wave reflecting element 100 overlapping the solar cell 200. The solar cell 200 includes a light guide 202 and a light-receiving portion 204, the light guide 202 is formed, for example, of a light guide plate 202. The surface of the light guide plate 202 has an uneven structure. The uneven structure may be provided on only one of the first surface F1 side and the second surface F2 side of the light guide plate 202, or on both surfaces. The uneven structure may have a periodic uneven structure, or the unevenness may be random (frosted glass-like) with irregularity. The light guide plate 202 is formed of a resin material such as acrylic or an inorganic material such as glass.

Fine particles with a different refractive index, such as titanium oxide, may be dispersed in the light guide plate 202.

According to the configuration of the light guide 202, the surface reflection of external light can be reduced and the amount of light incident on the photovoltaic element 204 can be increased by guiding the incident light. In addition, since the light guide plate 202 is formed of a dielectric material and the uneven structure formed on the surface does not have any effect on radio waves, the attenuation of radio waves incident on and reflected by the radio wave reflecting element 100 can be prevented. Other configurations are the same as in the first embodiment, and the same effects can be obtained.

The configuration of the light guide 202 shown in this embodiment can be replaced by the light guide 202 in the second through fifth embodiments.

### Seventh Embodiment

The radio wave reflecting device 300 according to the present embodiment has a configuration (more precisely, the configuration in which the light guide 202 is placed on top of the radio wave reflecting element 100) in which the solar cell 200 is arranged on top of the radio wave reflecting element 100, to improve the gain of the reflected radio wave, and it is preferable that the light guide 202 and the first substrate 150 of the radio wave reflecting element 100 have a predetermined thickness.

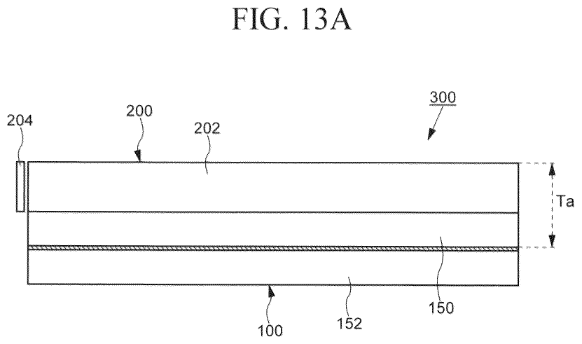

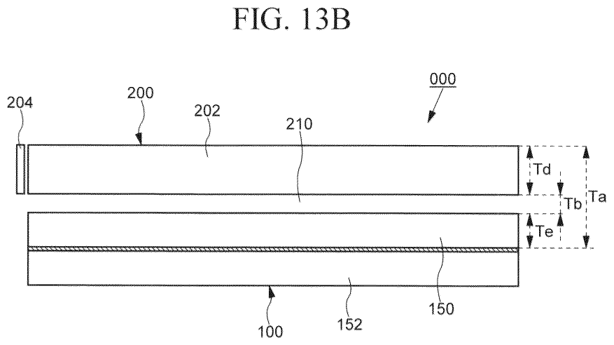

FIG. 13A shows a cross-sectional view of the radio wave reflecting device 300. FIG. 13A shows the radio wave reflecting element 100 and the light guide 202 configuring the solar cell 200 closely together, and the total thickness of the first substrate 150 and the light guide 202 is Ta. A transparent adhesive may be interposed between the first substrate 150 and the light guide 202 in the configuration shown in FIG. 13A. The refractive index of the transparent adhesive is preferably approximately the same as that of the first substrate 150 or the light guide 202.

The thickness Ta, which is the total thickness of the light guide 202 and the first substrate 150, is preferably equivalent to λ/4 (quarter of the wavelength) when the wavelength of the radio wave is λ. In other words, it is confirmed that the amplitude of the reflected wave can be increased when the thickness Ta is in a relationship satisfying the following equation (1) when the wavelength of the incident radio wave is set to A.

$$T = \frac{1}{4} λ \pm 0.2 mm \qquad ( 1 )$$

Here, λ/4=(c/f)/ε^{0.5}/4, where c is the speed of light, f is the frequency of radio waves, and ε is the relative permittivity of the light guide 202 and the first substrate 150.

It is possible to prevent attenuation of reflected waves by having the total thickness Ta of the first substrate 150 and the light guide 202 equivalent to ¼ of the wavelength of the radio wave. In this case, even if the thickness of the first substrate 150 is kept constant, the light guide 202 may be selected to satisfy the relationship in Equation (1) according to the frequency of the target radio wave, and the configuration of this embodiment allows for greater flexibility in the design of the radio wave reflecting device 300.

As shown in FIG. 13B, an air layer 210 may be interposed between the first substrate 150 and the light guide 202. In this configuration, when the thickness Tb of the air layer 210 is equal to or less than one-tenth of the wavelength of the incident radio wave (Tb<λ/10), the thickness Tc (Tc=Tb+Td+Te: Te is the thickness of the first substrate 150 and Td is the thickness of the light guide 202) is preferably equal to ¼ wavelength of the radio wave.

On the other hand, when the thickness Tb of the air layer is greater than the wavelength of the incident radio wave (Tb>λ), the thickness Te of the first substrate 150 and the thickness Td of the light guide 202 is preferably equivalent to ¼ wavelength of the radio wave, respectively.

According to the configuration of the radio wave reflecting device 300 of the present embodiment, the attenuation of radio waves reflected by the radio wave reflecting element 100 can be prevented and the gain of the reflected waves can be improved. The other configurations are the same as in the first embodiment, and the same effects can be obtained.

The configuration of the light guide 202 shown in this embodiment can be replaced by the light guide 202 in the second to sixth embodiments.

As described above, each configuration of the radio wave reflecting device shown in the first through the seventh embodiments can be combined as appropriate, as long as they do not contradict each other. Also, based on each embodiment, changes which a person skilled in the art has added, deleted, or changed the design of the configuration, or added, omitted, or changed the conditions of the process, as appropriate, are also included in the scope of the present invention, as long as they have the gist of the invention.

It is understood that other advantageous effects different from the advantageous effects brought about by the above-described embodiments, which are obvious from the description herein or which can be easily foreseen by those skilled in the art, are naturally brought about by the present invention.

What is claimed is:

1. A radio wave reflecting device comprising:
a radio wave reflecting element; and
a solar cell,
the radio wave reflecting element comprising:
a first substrate provided with bias electrodes arranged in a matrix;
a second substrate provided with a common electrode facing the first substrate and overlapping the bias electrode; and
a liquid crystal layer between the first substrate and the second substrate,
the solar cell comprising:
a light guide having a first surface and a second surface opposite the first surface and a side surface between the first surface and the second surface; and
a light-receiving portion provided along the side surface,
wherein
the second surface of the solar cell is arranged to face the first substrate of the radio wave reflecting element, and
a light receiving surface of the light-receiving portion is arranged on a side of the light guiding portion.

2. The radio wave reflecting device according to claim 1, further comprising a functional member,
wherein the functional member is disposed on the second surface of the light guide.

3. The radio wave reflecting device according to claim 2, wherein the functional member is a reflective diffraction lattice.

4. The radio wave reflecting device according to claim 2, wherein the functional member is an optical diffraction layer formed of a liquid crystal material.

5. The radio wave reflecting device according to claim 2, wherein the functional member is a light scatterer.

6. The radio wave reflecting device according to claim 1, further comprising a wavelength conversion layer as a functional member,
wherein the wavelength conversion layer is disposed on the first surface side of the light guide.

7. The radio wave reflecting device according to claim 1, wherein a surface of the light guide has an uneven structure.

8. The radio wave reflecting device according to claim 1, further comprising fine particles having a different refractive index from the light guide,
wherein the fine particles are dispersed in the light guide.

9. The radio wave reflecting device according to claim 1, wherein a total thickness of the light guide and the first substrate is equivalent to a quarter of the wavelength of a radio wave incident on the radio wave reflecting element.

10. The radio wave reflecting device according to claim 1, wherein a void is provided between the light guide and the first substrate, and a thickness of the void is less than one-tenth of the wavelength of a radio wave incident on the radio wave reflecting element, and
a total thickness of the light guide and the first substrate is equivalent to a quarter of the wavelength of a radio wave incident on the radio wave reflecting element.

11. The radio wave reflecting device according to claim 1, wherein a void is provided between the light guide and the first substrate, and a thickness of the void is greater than the wavelength of a radio wave incident on the radio wave reflecting element, and
each of the light guide and the first substrate has a thickness equivalent to a quarter of the wavelength of a radio wave incident on the radio wave reflecting element.
